(19) United States
(12) Patent Application Publication
(10) Pub. No.: US 2015/0260892 A1
(43) Pub. Date: Sep. 17, 2015

(54) DISPLAY APPARATUS

(71) Applicant: InnoLux Corporation, Miao-Li County (TW)

(72) Inventors: Cheng-Hsia KUO, Miao-Li County (TW); Wen-Kuen CHEN, Miao-Li County (TW); Tai-Chi PAN, Miao-Li County (TW)

(21) Appl. No.: 14/635,232

(22) Filed: Mar. 2, 2015

Related U.S. Application Data
(60) Provisional application No. 61/951,587, filed on Mar. 12, 2014.

(30) Foreign Application Priority Data
Oct. 7, 2014 (TW) 103134863

(51) Int. Cl. G02B 5/30; G02B 5/08

(52) U.S. Cl. CPC G02B 5/30; G02B 5/08

(57) ABSTRACT

A display apparatus and a touch display apparatus are disclosed, particularly, a display panel with functions including displaying and mirror reflection is disclosed. The display apparatus comprises display panel, a reflecting film disposed above the display panel, wherein the reflecting film has a first penetrating axes, wherein a display light is emitted from the display panel in a light-emitting direction, when an ambient light irradiates onto the display panel in a direction that different from the light-emitting direction, the ambient light with a polarization direction that different from the first transmission axes is reflected by the reflecting film.

### CROSS REFERENCE TO RELATED APPLICATION

This application claims the benefits of the Taiwan Patent Application Serial Number 103134863, filed on Oct. 7, 2014, the subject matter of which is incorporated herein by reference.

This application claims the benefit of filing date of U.S. Provisional Application Ser. No. 61/951,587, entitled “Mirror Display Apparatus” filed Mar. 12, 2014 under 35 USC §119(e)(1).

### BACKGROUND OF THE INVENTION

1. Field of the Invention

The present disclosure relates to a display apparatus, more particular, to a mirror display apparatus having a display function and a reflection function simultaneously.

2. Description of Related Art

For the popularity of Digital video devices, the development of the display technology continues to expand its applications fields, and the development of the display technology gradually moving toward multi-function display devises to realize the intelligent living style so that all kinds of messages may be readily received in daily life.

A mirror device having display function may provide the display and reflection functions at the same time.

If the mirror device having display function is used to replace various types of mirrors used in ordinary life, such as auxiliary mirror for cars, elevator mirror, or dressing mirror, or to replace various types of common display devices, such as smart phones, tablet PCs, or TVs, the features of those devices may be enriched, and may provide the interactions between the display messages and the users.

Currently, the recent mirror display apparatus serve as a mirror while the display area thereof does not display any information, and in those recent mirror display apparatus, the mirror is prepared by depositing a metal thin film on a surface of a transparent glass for reflecting the light irradiates from the outer environment. However, when the metal film serves as a mirror, the high extinction coefficient (K) of metal may lower the transmittance (T) of the display light emitting from the display panel that equipped with the said mirror display, for example, T˜exp(−K/λ), wherein λ is the wavelength of light. As a result, the brightness of the display must be increased in order to compensate the loss of the display brightness that caused by the metal thin film, and to realize a better display quality. However, it is energy-consuming to increase the brightness of the display. In addition, the shielding effect of the metal thin film may fail the electrical function (such as touch function) of components under the metal thin film. Therefore, the use of the metal reflecting film fails to provide an excellent mirror display apparatus with multi-functions.

Therefore, it is desirable to provide a novel mirror display apparatus with excellent reflection function and display function that may increase the reflection rate and increase the transmittance of the display light emitted from the display.

### SUMMARY OF THE INVENTION

The object of the present invention is to provide a display apparatus comprising a reflecting film, which provides the mirror reflection function. The reflecting film reduces the influence of the transmittance of the display panel, and provides the need of mirror reflecting effect at the same time.

Another object of the present invention is to provide a touch display apparatus. In addition to the excellent display and reflection functions, the touch element provides a touch-control function to operate the display panel.

To achieve the above object, the display apparatus of the present invention comprises: a display panel, a reflecting film disposed above the display panel, wherein the reflecting film has a first transmission axes, wherein a display light is emitted from the display panel in a light-emitting direction, when an ambient light irradiates onto the display apparatus in a direction that different from the light-emitting direction, the ambient light with a polarization direction that different from the first transmission axes is reflected by the reflecting film.

The display apparatus of the present invention further comprises a first polarizing plate having a second transmission axes, wherein an angle between the second transmission axes and the first transmission axes is larger than or equal to 0° and smaller than 90°, and is preferred to be larger than or equal to 0° and smaller than 45°. When an angle between the polarization direction of the display light and the first transmission axes of the reflecting film is 0°, the display light that penetrates through the reflecting film has the maximum light intensity, and the light intensity of the display light that penetrates through the reflecting film decreases while increasing the angle between the polarization direction of the display light and the first transmission axes of the reflecting film.

The display apparatus of the present invention further comprises a second polarizing plate having a third transmission axes, and the third transmission axes substantially perpendicular to the second transmission axes of the first polarizing plate.

According to the display apparatus of the present invention, the ambient light includes a red light (R), a green light (G), and a blue light (B), when a reflecting ratio of the ambient light that reflected by the reflecting film satisfies a range of 0.84<G/B<1.09 and 0.84<R/B<1.06, the reflecting film presents a silver color; and when the reflecting ratio of the ambient light that reflected by the reflecting film satisfies a range of 1.19<G/B<16.82 and 1.19<R/B<23.18, the reflecting film presents a champagne gold color; wherein a wavelength of the red light is 630 nm, a wavelength of the green light is 550 nm, and a wavelength of the blue light is 450 nm.

According to the display apparatus of the present invention, the display panel may be a liquid crystal display panel, an organic light emitting diode display panel, a plasma display panel, or a field emission display panel. When the display panel is the organic light emitting diode display panel or the plasma display panel, the second polarizing plate may not be included in the display apparatus of the present invention.

Moreover, in the display of the present invention, the reflecting film is preferably formed by dielectric reflective film stack (non-metal material), wherein the dielectric reflective film stack is designed to realize the needs for its reflectivity, and is formed by alternately stacking the film with high refractive index and the film with low refractive index. When the number of the stacked films is large, the transmission (T) and the reflectivity of the reflecting film satisfy the following equation (I) and equation (II):

T≈4(N_{L}/N_{H})^{2P}×N_{S}/N_{H}² (I)

R≈1-4(N_{L}/N_{H})^{2P}×N_{S}/N_{H}² (II)

wherein N_{L} is the refractive index of the film with low refractive index; N_{H} is the refractive index of the film with high refractive index; N_{S} is the refractive index of the substrate; and P is the number of the stacked films.

According to the equation (I) and equation (II), when each film with a high refractive index or a low refractive index is added to the reflecting film, the transmission (T) is decreased in a degree of (N_{L}/N_{H})², on the contrast, reflectivity (R) is increased.

Accordingly, the metal thin film of the prior art is replaced by the above-mentioned reflecting film as the reflecting film of the present invention. The reflecting film used in the present invention has a transmission axes and a reflection axes, wherein the transmission axes is perpendicular to the reflection axes. The operation principle of the reflecting film is described with reference of FIG. 1, wherein the ambient light has a variety of different polarization directions (isotropic), and the phase of the ambient light is a summation of random distributed planar polarized lights. The ambient light may be divided into two linearly polarized lights wherein the polarization directions thereof are perpendicular to each other, but the phases thereof may be randomly changed. The polarization directions are directed to the electric field. In one embodiment of the present invention, the ambient light include light P₁′ and light P₂′ with two polarization direction respectively, and the transmission axes of the reflecting film is parallel to the polarization direction of light P₁′. Therefore, when light P₁′ with the polarization direction that parallel to the transmission axes of the reflecting film is irradiates onto the reflecting film 13, light P₁′ may penetrate through the reflecting film and reach the other side of the reflecting film 13. However, when light P₂′ with the polarization direction that different from the transmission axes of the reflecting film 13, light P₂′ is reflected by the reflecting film. Similarly, the light emitted from the display modulus includes light P₁ and light P₂ with two polarization direction respectively, and when polarization direction of light P₁ is parallel to the transmission axes of the reflecting film 13, light P₁ may penetrates through the reflecting film 13 and enters the observation side. In addition, when the polarization direction of light P₂ is different from the transmission axes of the reflecting film 13, light P₂ is reflected by the reflecting film 13 and fail to enter the observation side. Therefore, when the reflecting film is disposed on the display panel in the display apparatus of the present invention, the display light with a polarization direction that parallel to the transmission axes of the reflecting film may penetrates through the reflecting film and reach the observation side of the display apparatus. On the contrast, if the polarization direction of the light irradiates from the observation side of the display apparatus is different from the transmission axes of the reflecting film, the light irradiates from the observation side of the display is reflected by the reflecting film is mirrored, so that the display images and the mirror images can be observed simultaneously on the observation side of the display apparatus. When the display panel is a liquid crystal display panel, the display panel further comprises a first polarizing plate, which is disposed between the display panel and the reflecting film 13, wherein the transmission axes of the first polarizing plate is parallel to the transmission axes of the reflecting film 13, the liquid crystal type mirror display apparatus has the maximum transmittance.

In addition, to achieve another object of the present invention, a touch display apparatus is provided, which comprises: a display panel, comprising a first polarizing plate; a reflecting film disposed above the display panel, wherein the reflecting film has a first transmission axes, and a protective film disposed above the reflecting film; wherein a display light is emitted from the display panel in a light-emitting direction, when an ambient light irradiates onto the display panel in a direction that different from the light-emitting direction, the ambient light with a polarization direction that different from the first transmission axes is reflected by the reflecting film.

### BRIEF DESCRIPTION OF THE DRAWINGS

FIG. 1 is a schematic diagram of the operation principle of the reflecting film;

FIG. 2 is a cross-sectional view of the mirror display apparatus of Embodiment 1;

FIG. 3 is a cross-sectional view of the mirror display apparatus of Embodiment 1;

FIG. 4 is a cross-sectional view of the touch mirror display apparatus of Embodiment 2;

FIG. 5 is a cross-sectional view of the touch mirror display apparatus of Embodiment 3;

FIG. 6 is a cross-sectional view of the touch mirror display apparatus of Embodiment 4;

FIG. 7 is a cross-sectional view of the touch mirror display apparatus of an embodiment;

FIG. 8 is a cross-sectional view of the touch mirror display apparatus of an embodiment;

FIGS. 9A, 9B are cross-sectional views of the touch mirror display apparatus of an embodiment;

FIG. 10 is a cross-sectional view of the display apparatus of Embodiment 5;

FIG. 11 is a cross-sectional view of the touch display apparatus of Embodiment 6;

FIG. 12 is a cross-sectional view of the touch display apparatus of Embodiment 7;

FIG. 13 is a cross-sectional view of the touch display apparatus of Embodiment 8;

FIGS. 14-17 are schematic diagrams of the applications of the display apparatus of the present invention.

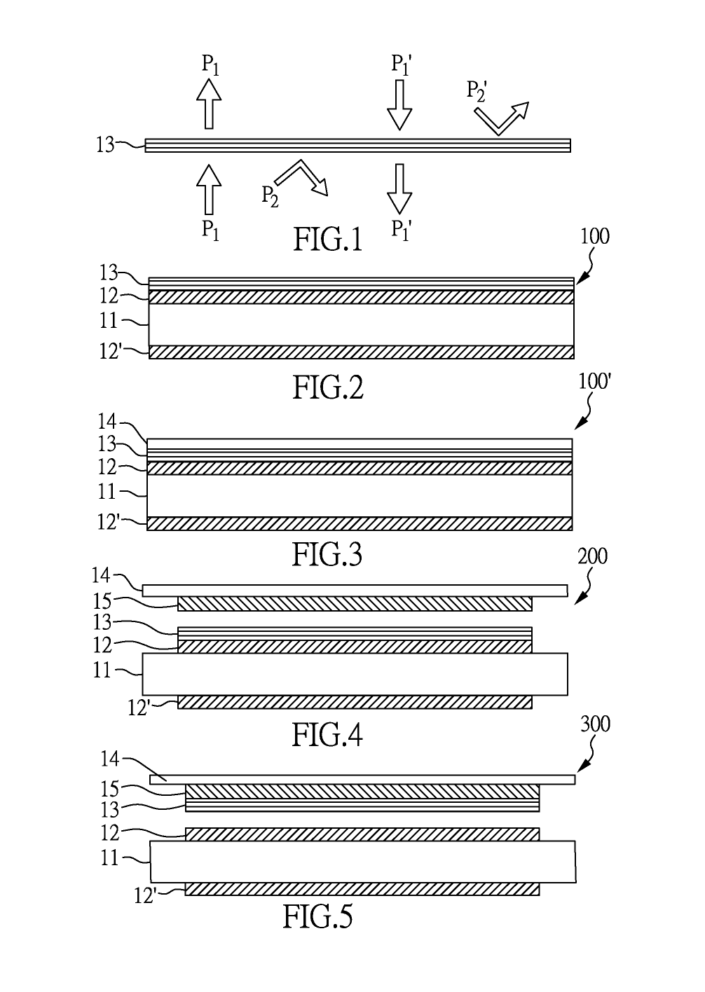

### DETAILED DESCRIPTION OF THE EMBODIMENT

Hereafter, examples will be provided to illustrate the embodiments of the present invention. Other advantages and effects of the invention will become more apparent from the disclosure of the present invention. It should be noted that these accompanying figures are simplified. The quantity, shape and size of components shown in the figures may be modified according to practically conditions, and the arrangement of components may be more complex. Other various aspects also may be practiced or applied in the invention, and various modifications and variations can be made without departing from the spirit of the invention based on various concepts and applications.

### Embodiment 1

With reference to FIG. 2, there is shown a mirror display apparatus 100 of the present invention, the mirror display apparatus 100 comprises: a display panel 11, a first polarizing plate 12 disposing on the display panel 11, a second polarizing plate 12′ disposing under the display panel 11, and a reflecting film 13 disposing on the first polarizing plate 12. In the present embodiment, the reflecting film 13 has a first transmission axes, when a light with a polarization direction parallel to the first transmission axes of the reflecting film 13 irradiates onto the reflecting film, the light may penetrates into the reflecting film 13. However, if the polarization direction of the light irradiating onto the reflecting film is different from the first transmission axes of the reflecting film, portions of the light may be reflected by the reflecting film 13, and portions of the light may still penetrates through the reflecting film 13. In an embodiment, the first polarizing plate 12 has a second transmission axes, and the second polarizing plate 12′ has a third transmission axes, wherein the second transmission axes is substantially perpendicular to the third transmission axes.

On the present embodiment, an angle between the second transmission axes of the first polarizing plate 12 and the first transmission axes of the reflecting film 13 is larger or equal to 0°, and smaller than 90°, wherein larger or equal to 0°, and smaller than 45° is preferred, 0° is most preferable, that is the second transmission axes of the first polarizing plate 12 is most preferable perpendicular to the first transmission axes of the reflecting film 13. In this case, the display light emitted from the display element 11 that penetrates through the first polarizing plate 12 has a first polarization direction P1. When the first polarization direction P1 of the display light is parallel to the first transmission axes of the reflecting film 13, the display light with the first polarization direction P1 can penetrate through the reflecting film 13 and enter to the observation side. The intensity of the penetrated display light decreases as the angle between the first transmission axes of the reflecting film 13 and the second transmission axes of the first polarizing plate 13 increases. Therefore, the angle may be designed within the above-mentioned ranges based on the needs. When the angle between the first transmission axes of the reflecting film 13 and the second transmission axes of the first polarizing plate 12 is 0°, the mirror display apparatus may exhibit the maximum brightness.

Furthermore, in the present embodiment, the display panel 11 is a liquid display panel, and the liquid display panel may be any kinds of liquid display panel known in the art, which may comprises a upper substrate, a lower substrate, alignment layer, liquid crystal layer, thin film transistor, backlight modulus, or the like, the present invention is not particular limited. The display panel may be an In-Plane-Switching Liquid Crystal (IPS) or a vertical alignment liquid crystal (VA), which is not particular limited.

Further, in the present embodiment, as shown in FIG. 2, the reflecting film 13 is disposed on the first polarizing plate 12. In other embodiments, the reflecting film 13 is only required to be disposed above the first polarizing plate 12, so that the other layers may be inserted between the first polarizing plate 12 and the reflecting film 13, or there may be a gap between the first polarizing plate 12 and the reflecting film 13, which is not particularly limited.

In addition, as shown in FIG. 2, the reflecting film 13 is disposed at the most outer layer of the mirror display apparatus 100; it is likely to cause damage or deterioration of the reflecting film 13. Therefore, as shown in FIG. 3, an additional protective film 14 may be disposed on the reflecting film 13 to protect the reflecting film 13 and the display panel 11. In an embodiment, the protective film 14 shown in FIG. 3 is composed of glass plate. But in other embodiments, the protective film 14 may be any material known in the art to provide the protection for the mirror display apparatus 100′. For example, glass materials such as heat tempered glass, chemical tempered glass, laminated glass, or the like, or polymer materials such as silicone, resin, acrylic, or the like may be used as the protective film. In another embodiment, the protective film 14 may be a hard coating film, or anti-dirt or anti-scratch coating materials.

For the mirror display apparatus 100′ shown in FIG. 3, the manufacturing method thereof may comprise: sequentially stacked the display panel 11, the first polarizing plate 12, the reflecting film 13, and the protective film 14. Alternatively, the first polarizing plate 12 may be first attached to the display panel 11, and also the reflecting film 13 may be first attached to the protective film 14, and then combine the first polarizing plate 12 and the reflecting film 13, to accomplished the mirror display apparatus 100′.

### Embodiment 2

FIG. 4 shows the touch mirror display apparatus 200 of the present embodiment, wherein the touch mirror display apparatus 200 comprises a display panel 11, a first polarizing plate 12 disposed on the display panel 11, a second polarizing plate 12′ disposed under the display panel 11, a reflecting film 13 disposed on the first polarizing plate 12, a touch element 15 disposed above the reflecting film, and a protective film 14 disposed on the touch element 15. The display panel 11, the first polarizing plate 12, the second polarizing plate 12′, the reflecting film 13, and the protective film 14 are the same as described above. Therefore, any description in the above Embodiment is incorporated herein insofar as the same is applicable, and the same description need not be repeated.

The touch element 15 of the present invention may be any types of touch sensor known in the art, for example, the touch element may be composed by a mono-layer touch thin film or a bi-layer touch thin film. The type of the touch sensing technology may be a resistive touch element, a surface capacitive touch element, a projected capacitive touch element, an electromagnetic touch element, an acoustic touch element, or an infrared touch element. Alternatively, in other embodiments, the touch element 15 and the protective film 14 can be replaced by a Window integrated sensor (WIS), wherein the touch element 15 is formed directly on the protective film 14. The protective film 14 may be a glass plate, or may be a barrier layer with anti-scratching or anti-dirt properties. In the present invention, the disposing area of touch element 15 may be a portion or the whole area of the mirror display apparatus, which depends on the design of the mirror display apparatus.

In the present embodiment, the touch element 15 is disposed above the reflecting film 13 with a gap between them. In other embodiments, the touch element 15 is only required to be disposed above the reflecting film 13, so that the other layers may be inserted between the touch element 15 and the reflecting film 13, or the touch element 15 and the reflecting film 13 may directly contact to each other, which is not limited thereto.

### Embodiment 3

FIG. 5 shows the touch mirror display apparatus 300 of the present embodiment, wherein the touch mirror display apparatus 200 comprises a display panel 11, a first polarizing plate 12 disposed on the display panel 11, a second polarizing plate 12′ disposed under the display panel 11, a reflecting film 13 disposed above the first polarizing plate 12, a touch element 15 disposed on the reflecting film, and a protective film 14 disposed on the touch element 15. The display panel 11, the first polarizing plate 12, the second polarizing plate 12′, the reflecting film 13, and the protective film 14 are the same as described above. Therefore, any description in the above Embodiment is incorporated herein insofar as the same is applicable, and the same description need not be repeated.

Alternatively, in other embodiments, the touch element 15 and the protective film 14 can be replaced by a Window integrated sensor (WIS).

In the present embodiment, the reflecting film 13 is disposed above the first polarizing plate 12 with a gap between them. However, in other embodiments, the reflecting film 13 is only required to be disposed above the first polarizing plate 12, so that the other layers may be inserted between the reflecting film 13 and the first polarizing plate 12, or the reflecting film 13 and the first polarizing plate 12 may directly contact to each other, which is not limited thereto.

### Embodiment 4

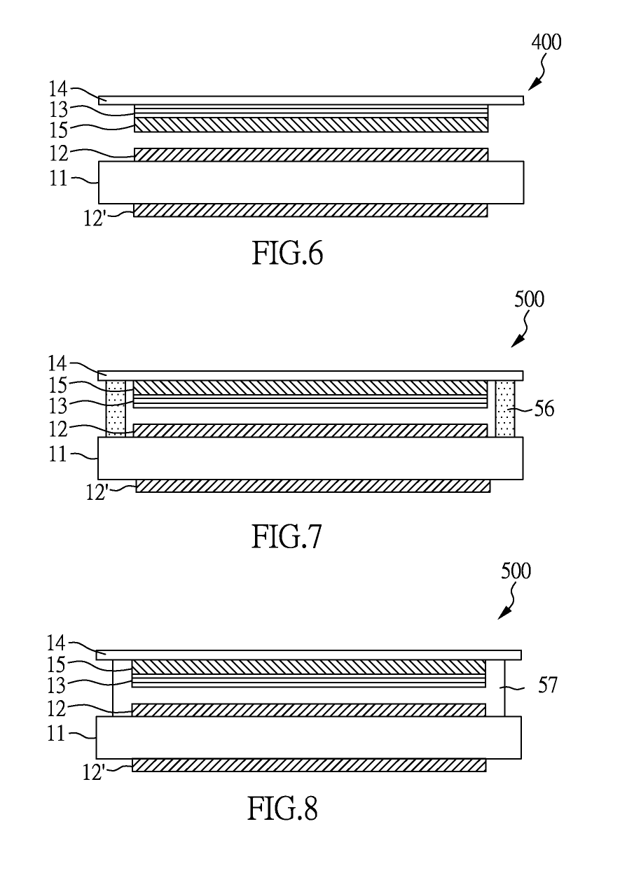

FIG. 6 shows the touch mirror display apparatus 400 of the present embodiment, wherein the touch mirror display apparatus 400 comprises a display panel 11, a first polarizing plate 12 disposed on the display panel, a second polarizing plate 12′ disposed under the display panel 11, a touch element 15 disposed above the first polarizing plate 12, a reflecting film 13 disposed on the touch element 15, and a protective film 14 disposed on the reflecting film 13. The display panel 11, the first polarizing plate 12, the second polarizing plate 12′, the reflecting film 13, and the protective film 14 are the same as described above. Therefore, any description in the above Embodiment is incorporated herein insofar as the same is applicable, and the same description need not be repeated.

However, in the present embodiment, the reflecting film 13 is disposed between the touch element 15 and the protective film 14, and the touch element 15 is disposed above the first polarizing plate 12 with a gap between them. In other embodiments, the touch element 15 is only required to be disposed above the first polarizing plate 12, so that the other layers may be inserted between the touch element 15 and the first polarizing plate 12, or the touch element 15 and the first polarizing plate 12 may directly contact to each other, which is not limited thereto.

According to the touch mirror display apparatus of Embodiments 2-4 that described above, these touch mirror display apparatus may be bonded by air-bonding method of full lamination. As shown in FIG. 7, the air-bonding method may be performed by applying the sealant 56 to accomplish the touch mirror display apparatus 500. In other embodiments, air-bonding method may be performed by applying tape. In other embodiments, the touch mirror display apparatus 500 may be accomplished by performing a full lamination using molding compound 57.

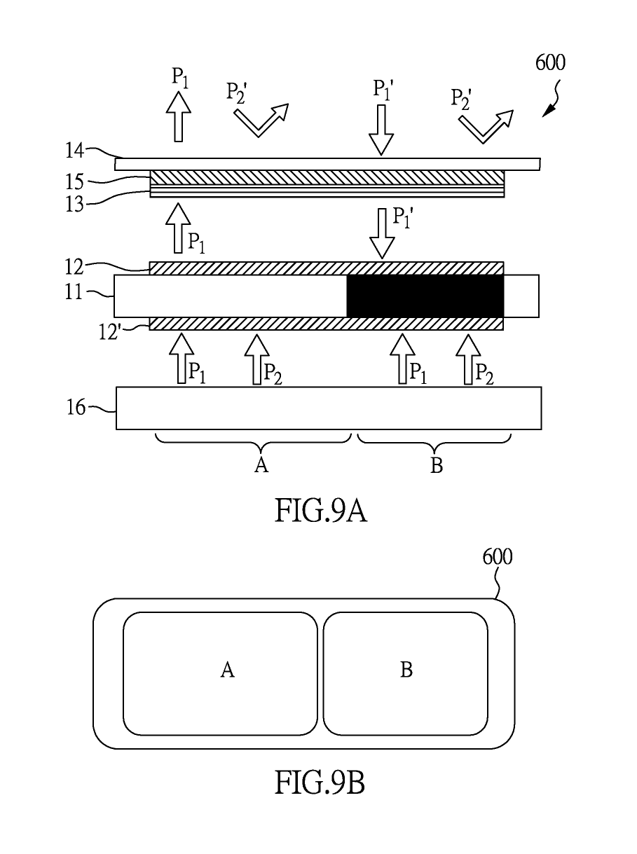

In Embodiments 2-4, the touch mirror display apparatus with touch elements are disclosed. These touch mirror display apparatus may function for displaying messages, mirror reflection, and touch-controlling. Therefore, through the operation by the touch function, portions of the mirror display apparatus area may functions for displaying messages, and portions of the mirror display apparatus area may functions for mirror reflection. As shown in FIG. 9A and FIG. 9B, the ambient light has a variety of different polarization directions (isotropic), and the phase of the ambient light is a summation of random distributed planar polarized lights. The ambient light may be divided into two linearly polarized lights, wherein the polarization directions thereof are perpendicular to each other, but the phases thereof may be randomly changed. The polarization directions are directed to the electric field. In the present embodiments, the ambient light include light P₁′ and light P₂′ with two polarization direction respectively. Further, when an ambient light irradiates onto the display panel in a direction that different from the light-emitting direction, a display light is emitted from the display panel in a light-emitting direction. During the operation of the mirror display apparatus 600, the mirror display apparatus 600 may be divided into displaying region A and reflection region B. The back light modulus 16 emits light toward the display panel 11, and when the light emitted from the back light modulus 16 penetrates through the second polarizing plate 12′, the light P₁ with polarization direction parallel to the transmission axes of the second polarizing plate 12′ may enters into the display panel 11, while the light P₂ with polarization direction that different from the transmission axes of the second polarizing plate 12′ may not enter the display panel 11. Further, in the displaying region A, light P₁ emitted from portions of the display panel 11 corresponding to the displaying region A penetrates through the first polarizing plate 12 and the reflecting film 13, and enters the observation side, thus the display messages may be observed by the audiences. In addition, portion of the display panel 11 that corresponds to the reflection region B does not emit any displaying light (black screen). In this case, the ambient light P₂′ with polarization direction different from the transmission axes is reflected by the reflecting film 13. In the meantime, the reflection region B only functions as a mirror to reflect the ambient light P₂′. For the ambient light P₁′ with polarization direction parallel to the transmission axes of the reflecting film 13, the ambient light P₁′ may penetrates through the reflecting film 13 and enters into the display panel 11. However, in the mirror display apparatus 600, the location, area, and the shape of the displaying region A and the reflection region B may be readjusted too meet the needs. For example, the displaying region A and the reflection region B may be adjusted by touch operation.

### Embodiment 5

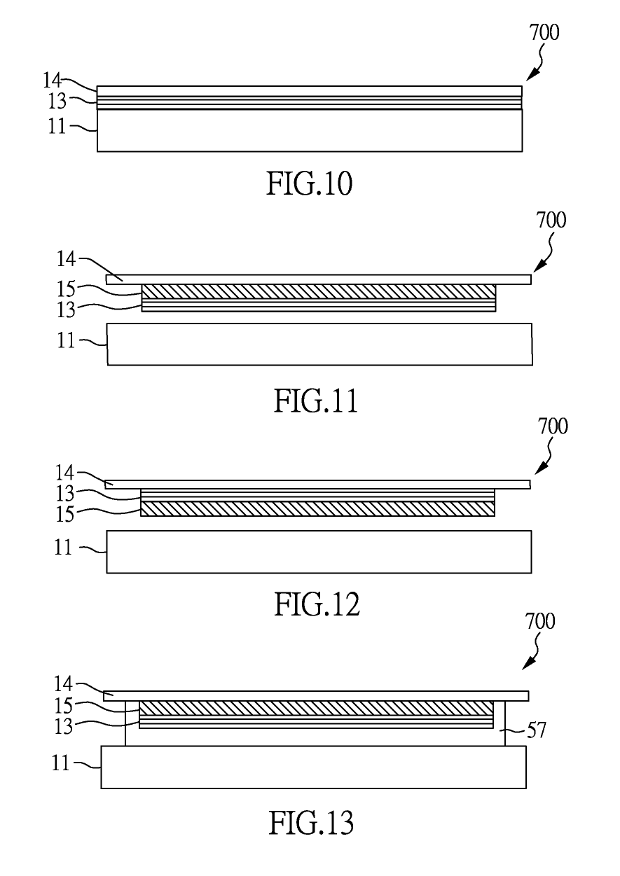

FIG. 10 is showing a display apparatus 700 of the present embodiment, wherein the display apparatus 700 comprises a display panel 11, a reflecting film 13 disposed on the display panel 11, and a protective film 14 disposed on the reflecting film 13. In the present embodiment, the display panel 11 is an organic light emitting diode panel of a plasma display panel, thus the first polarizing plate or the second polarizing plate is not included in the display apparatus.

### Embodiment 6

FIG. 11 is showing a display apparatus 700 of the present embodiment, wherein the display apparatus 700 comprises a display panel 11, a reflecting film 13 disposing above the display panel 11, a protective film 14 disposed above the reflecting film 13, and a touch element 15 disposed between the reflecting film 13 and the protective film 14. In the present embodiment, the display panel 11 is an organic light emitting diode panel of a plasma display panel, thus the first polarizing plate or the second polarizing plate is not included in the display apparatus.

However, in the present embodiment, the touch element 15 is disposed between the reflecting film 13 and the protective film 14, and the reflecting film 13 is disposed above the display panel 11 with a gap between them. In other embodiments, the reflecting film 13 is only required to be disposed above the display panel 11, so that the other layers may be inserted between the reflecting film 13 and the display panel 11, or the reflecting film 13 and the display panel 11 may directly contact to each other, which is not limited thereto.

### Embodiment 7

FIG. 12 is showing a display apparatus 700 of the present embodiment, wherein the display apparatus 700 comprises a display panel 11, a touch element 15 disposed on the display panel 11, a reflecting film 13 disposed on the display panel 11, and a protective film 14 disposed on the reflecting film 13. In the present embodiment, the display panel 11 is an organic light emitting diode panel of a plasma display panel, thus the first polarizing plate or the second polarizing plate is not included in the display apparatus.

However, in the present embodiment, the reflecting film 13 is disposed between the touch element 15 and the protective film 14, and the touch element 15 is only required to be disposed above the display panel 11 with a gap therebetween. In other embodiments, the touch element is only required to be disposed above the display panel 11, so that the other layers may be inserted between the touch element 15 and the display panel 11, or the touch element 15 and the display panel 11 may directly contact to each other, which is not limited thereto.

### Embodiment 8

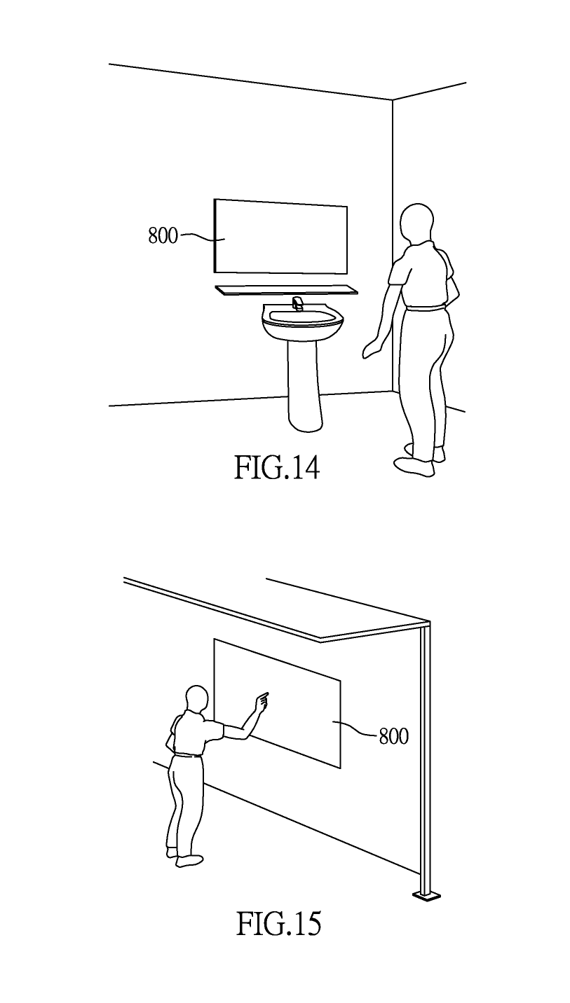

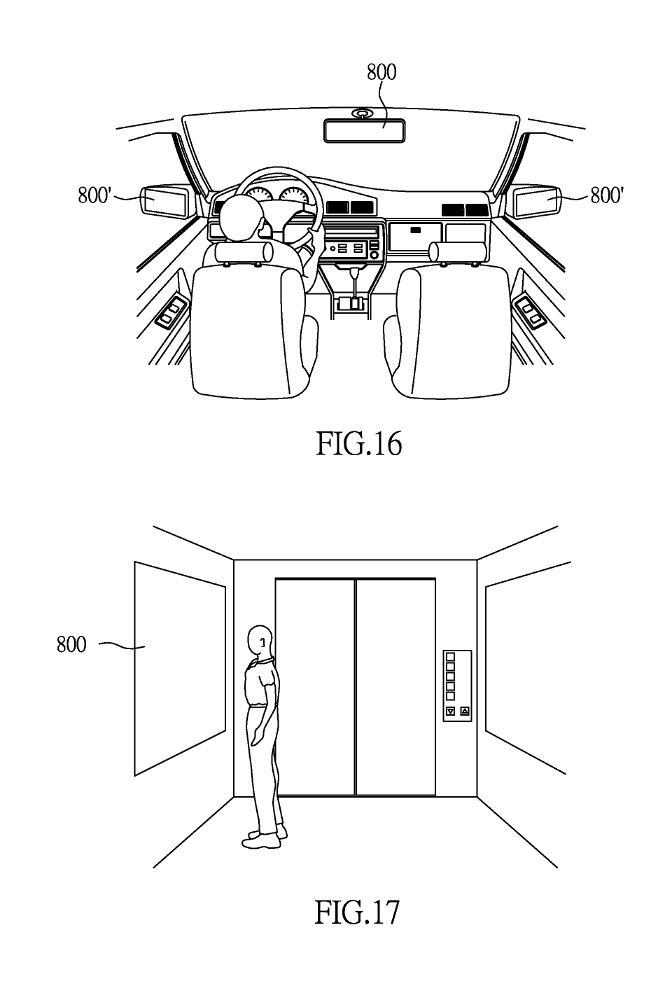

As shown in FIGS. 14-17, the present embodiment demonstrates a bonding method of performing a full lamination on the display apparatus of Embodiment 6 to accomplish the touch display apparatus 700 by using molding compound 57. However, the bonding method for the display apparatus and the touch display apparatus of the present invention is not particularly limited, and may be air-bonding method or full lamination.

Further, according to an embodiment of the present invention, the refracting index N_{L}, and N_{H} of the inner layers of the reflecting film may be adjusted according to their refractive index corresponding to different wavelength, wherein the refractive index N_{L} of the film with low refractive index and the refractive index N_{H} of the film with high refractive index. Therefore, the amounts of the reflected light with different wavelengths may be adjusted, so that the reflecting film may present different colors.

According to an embodiment of the present invention, when a reflecting ratio of the ambient light that reflected by the reflecting film satisfies a range of 0.84<G/B<1.09 and 0.84<R/B<1.06, the reflecting film may presents a silver color, wherein the ambient light includes a red light (R), a green light (G), and a blue light (B), and a wavelength of the red light is 630 nm, a wavelength of the green light is 550 nm, and a wavelength of the blue light is 450 nm.

According to another embodiment of the present invention, when a reflecting ratio of the ambient light that reflected by the reflecting film satisfies a range of 1.19<G/B<16.82 and 1.19<R/B<23.18, the reflecting film may presents a champagne gold color; wherein the ambient light includes a red light (R), a green light (G), and a blue light (B), and a wavelength of the red light is 630 nm, a wavelength of the green light is 550 nm, and a wavelength of the blue light is 450 nm.

The display apparatus provided by the present disclosure has multiple functions such as displaying messages, mirror reflection, and touch-controlling. Therefore, it can be applied in a wide range of fields. For example, the display apparatus of the present disclosure may be applied in any devices including display panel, such as laptops, video cameras, digital cameras, music players, mobile navigation devices, televisions, curve display, flexible display, and the like; or may be applied in any devices having the mirror function. For example, as shown in FIGS. 14-17, the display apparatus 800 provided by the present invention may be applied to cosmetic mirrors, information bulletin walls, car rearview mirrors (800, 800′), and mirrors in the elevator. Therefore, the display apparatus may be applied to provide the functions of mirror reflection and displaying messages at the same time, while the display apparatus can be operated by its touch-controlling function.

Although the present invention has been explained in relation to its embodiment, it is to be understood that many other possible modifications and variations can be made without departing from the spirit and scope of the invention as hereinafter claimed.

What is claimed is:

1. A display apparatus, comprising:
a display panel,
a reflecting film disposed above the display panel, wherein the reflecting film has a first transmission axes,
wherein an ambient light irradiates onto the display panel, the ambient light with a polarization direction that different from the first transmission axes is reflected by the reflecting film.

2. The display apparatus as claimed in claim 1, the display panel further comprising a first polarizing plate having a second transmission axes, wherein an angle between the second transmission axes and the first transmission axes is larger than or equal to 0° and smaller than 90°.

3. The display apparatus as claimed in claim 2, wherein the angle between the second transmission axes and the first transmission axes is larger than or equal to 0° and smaller than 45°.

4. The display apparatus as claimed in claim 1, wherein the ambient light includes a red light (R), a green light (G), and a blue light (B), when a reflecting ratio of the ambient light that reflected by the reflecting film satisfies a range of 0.84<G/B<1.09 and 0.84<R/B<1.06, the reflecting film presents a silver color; wherein a wavelength of the red light is 630 nm, a wavelength of the green light is 550 nm, and a wavelength of the blue light is 450 nm.

5. The display apparatus as claimed in claim 1, wherein the ambient light includes a red light (R), a green light (G), and a blue light (B), when a reflecting ratio of the ambient light that reflected by the reflecting film satisfies a range of 1.19<G/B<16.82 and 1.19<R/B<23.18, the reflecting film presents a champagne gold color; wherein a wavelength of the red light is 630 nm, a wavelength of the green light is 550 nm, and a wavelength of the blue light is 450 nm.

6. A display apparatus, comprising:
a display panel, comprising a first polarizing plate;
a reflecting film disposed above the display panel, wherein the reflecting film has a first transmission axes; and
a protective film disposed above the reflecting film;
wherein an ambient light irradiates onto the display panel, the ambient light with a polarization direction that different from the first transmission axes is reflected by the reflecting film.

7. The display apparatus as claimed in claim 6, wherein the first polarizing plate having a second transmission axes, wherein an angle between the second transmission axes and the first transmission axes is larger than or equal to 0° and smaller than 90°.

8. The display apparatus as claimed in claim 7, wherein the angle between the second transmission axes and the first transmission axes is larger than or equal to 0° and smaller than 45°.

9. The display apparatus as claimed in claim 6, wherein the ambient light includes a red light (R), a green light (G), and a blue light (B), when a reflecting ratio of the ambient light that reflected by the reflecting film satisfies a range of 0.84<G/B<1.09 and 0.84<R/B<1.06, the reflecting film presents a silver color; wherein a wavelength of the red light is 630 nm, a wavelength of the green light is 550 nm, and a wavelength of the blue light is 450 nm.

10. The display apparatus as claimed in claim 6, wherein the ambient light includes a red light (R), a green light (G), and a blue light (B), when a reflecting ratio of the ambient light that reflected by the reflecting film satisfies a range of 1.19<G/B<16.82 and 1.19<R/B<23.18, the reflecting film presents a champagne gold color; wherein a wavelength of the red light is 630 nm, a wavelength of the green light is 550 nm, and a wavelength of the blue light is 450 nm.
